(19) United States
(12) Patent Application Publication
(10) Pub. No.: US 2025/0078037 A1
(43) Pub. Date: Mar. 6, 2025

(54) CAREER MANAGEMENT CO-OP SYSTEM

(71) Applicant: Isotalent Inc., Lehi, UT (US)

(72) Inventors: Robb Lifferth, Lehi, UT (US); Paul Ahlstrom, Lehi, UT (US)

(21) Appl. No.: 18/824,572

(22) Filed: Sep. 4, 2024

Related U.S. Application Data
(60) Provisional application No. 63/580,410, filed on Sep. 4, 2023.

(51) Int. Cl. G06Q 10/1053

(52) U.S. Cl. CPC G06Q 10/1053

(57) ABSTRACT

Methods, systems, and apparatuses for a career management co-op platform. A method includes receiving, from a device associated with a prospective job candidate, a request for consideration for a first job type for the job candidate; and determining, based on aggregated job candidate data of a plurality of job candidates having the first job type, one or more relevant skills possessed by the plurality job candidates. The method further includes determining, via a machine learning inference based on a comparison of current skills possessed by the prospective job candidate and the relevant skills, a job seeker skillset match score; and based on the skillset match score satisfying a threshold, providing, to the device, a recommendation of a second job type relevant to at least one of the one or more relevant skills missing from the current skills of the prospective job candidate.

### CROSS-REFERENCE TO RELATED APPLICATION

This application claims priority to U.S. Provisional Application No. 63/580,410, filed on Sep. 4, 2023, the entirety of which is incorporated by reference herein.

### FIELD OF INVENTION

The present disclosure relates to a system and method for managing career-related data, particularly an individual's work history, skills, qualifications, and career progression. Specifically, the disclosure relates to the creation of a dynamic, artificial intelligence (AI)-powered career management tool that aggregates career data and provides personalized career guidance.

### BACKGROUND

Management of recruitment processes involves employers, recruiting agents, and jobseekers. With the increasing complexity of modern career paths, job seekers and employees require sophisticated tools to manage their work histories, skills, and education, as well as to match themselves with suitable job opportunities. Traditional resumes and curriculum vitae (CVs) often fail to capture the dynamic nature of an individual's skills and experience. As a result, there is a growing need for a solution that can dynamically manage and display a job seeker's career data, helping them align their skills with job market trends and educational requirements.

### SUMMARY

It is to be understood that both the following general description and the following detailed description are exemplary and explanatory only and are not restrictive. This application describes examples of a career management co-op platform (CMCP) system that uses artificial intelligence (AI) to infer skills from work history and other data sources, and dynamically generate a career blueprint that aligns an individual's skills with specific career goals and industry trends. This embodiments described herein further integrate with applicant tracking systems (ATSs) and human resource information systems (HRIS), to enhance the accuracy and efficiency of job matching. The CMCP may accelerate timelines and improve the quality of the applicant pool that employers historically have experienced when filling an open position as well as accelerating the time that it takes for a job seeker to find a new role that will help them to attain their career aspirations. The CMCP may aggregate data from client ATSs (e.g., collected via an application programming interface (API)), job boards, jobseekers directly, HRIS, etc., or any combination thereof. The aggregated data may provide higher quality data that will accelerate timelines for both a job seeker (e.g., applicant, candidate, etc.) and the employer with an open role. The CMCP use the aggregated data to suggest qualified candidates to participating hiring companies for open roles, which may benefit the participating hiring employers by enhancing a size of an actively-seeking qualified applicant pool and improve visibility into an expected time-to-fill (TTF) for any given role.

The CMCP may manage a digital resume or wallet that includes a comprehensive, user-controlled digital portfolio. The digital resume or wallet may aggregate an individual's work history, skills, qualifications, certifications, etc. The digital resume or wallet may collect data through multiple input methods, including direct user input, resume uploads, LinkedIn® profile integration, API connections to HRIS and ATS platforms, or any combination thereof. The AI may be employed to infer skill proficiencies and identify career gaps, helping individuals track and enhance their professional development.

In addition, the CMCP may manage a dynamic career blueprint powered by AI that maps a job seeker's skills, qualifications, and work history against career goals. The CMCP may identify skill gaps and suggests targeted educational pathways to bridge those gaps, and may continuously evolve based on job market trends and career advancement opportunities, supporting personalized career development.

Other examples are possible as well. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 illustrates a block diagram of a system for managing recruitment processes among job seekers (e.g., candidates) and employers in accordance with embodiments described herein.

FIG. 2 illustrates a block diagram of a system for managing recruitment processes among job seekers (e.g., candidates) and employers in accordance with embodiments described herein.

FIG. 3 illustrates a block diagram of a CMCP, in accordance with embodiments described herein

FIG. 4 is a block diagram depicting a system/environment in accordance with embodiments of the disclosure.

FIG. 5 depicts a flowchart of an example method to evaluate job seeker qualifications via a CMCP in accordance with embodiments of the disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intended to be limited to the four corners of each sheet presented. The techniques disclosed herein may be implemented on a computing device(s) in a way that improves performance and/or efficiency of operation, as further described herein.

The present invention discloses an Artificial Intelligence (AI) based career management co-op platform (CMCP) that aggregates data from data from employer applicant tracking systems, job boards, direct from jobseekers and provides information back to the employers (e.g., pool of qualified candidates, TTF estimates, validation of candidate information, etc.) and/or job seekers (e.g., jobs that candidate is qualified for, skill gaps, recommended career strategy, validation of information, etc.).

As used herein, ‘AI-module’ or ‘machine learning inference’ is an artificial intelligence enabled device or module, that is capable of processing digital logics and also possesses analytical skills for analyzing and processing various data or information, according to the embodiments of the present invention.

As used herein, ‘data storage’ refers to a local or remote memory device; docket systems; storage units; databases; each capable to store information including, voice data, speech to text transcriptions, customer profiles and related information, audio feeds, metadata, predefined events, call notes, etc. In an embodiment, the storage unit may be a database server, a cloud storage, a remote database, a local database.

As used herein, ‘device’ or ‘system’ may refer to a device, a system, a hardware, a computer application configured to execute specific functions or instructions according to the embodiments of the present invention. The module or unit may include a single device or multiple devices configured to perform specific functions according to the present invention disclosed herein.

Terms such as ‘connect’, ‘integrate’, ‘configure’, and other similar terms include a physical connection, a wireless connection, a logical connection or a combination of such connections including electrical, optical, RF, infrared, Bluetooth, or other transmission media, and include configuration of software applications to execute computer program instructions, as specific to the presently disclosed embodiments, or as may be obvious to a person skilled in the art.

Terms such as ‘send’. ‘transfer’, ‘transmit’ and ‘receive’, ‘collect’, ‘obtain’, ‘access’ and other similar terms refers to transmission of data between various modules and units via wired or wireless connections across a network. The ‘network’ includes a local area network (LAN), a wide area network (WAN), a metropolitan area network (MAN), a virtual private network (VPN), an enterprise private network (EPN). Internet, cloud-based network, and a global area network (GAN).

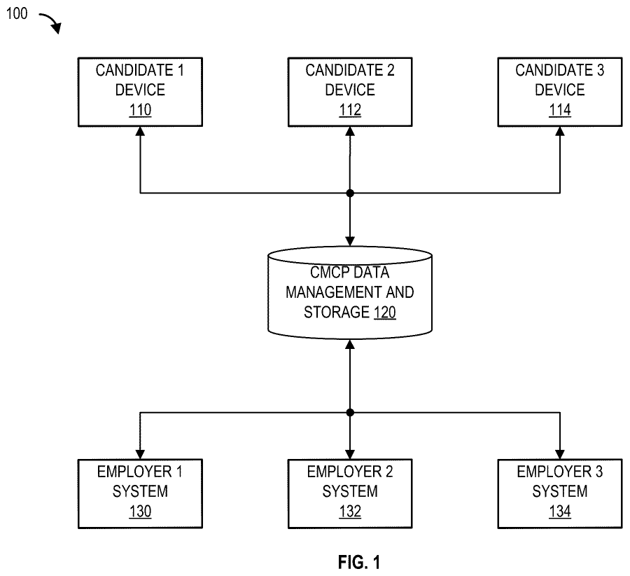

FIG. 1 illustrates a block diagram of a system 100 for managing recruitment processes among job seekers (e.g., candidates) and employers in accordance with embodiments described herein. The system 100 may include candidate devices 110, 112, and 114, a CMCP data management and storage system 120, and employer systems 130, 132, and 134. The candidate devices 110, 112, and 114, a CMCP data management and storage system 120, and employer systems 130, 132, and 134 may be in communication over a network (e.g., any wireless or wired network, or combination thereof). The candidate devices 110, 112, and 114 may be associated with one or more job seekers or candidates.

The candidate devices 110, 112, and 114 may be operated by one or more job seekers to communicate with the employer systems 130, 132, and 134 to apply for jobs, retrieve job status, etc. The candidate devices 110, 112, and 114 may also communicate with the CMCP data management and storage system 120 to store and retrieve personal information, job posting information, and other information managed by the CMCP data management and storage system 120.

The employer systems 130, 132, and 134 may be operated by one or more employers to communicate with the candidate devices 110, 112, and 114 to provide job listing information, receive applications for jobs, retrieve job status, etc. The employer systems 130, 132, and 134 may also communicate with the CMCP data management and storage system 120 to store and retrieve candidate information, recommendations of qualified candidates, update job posting status, and other information managed by the CMCP data management and storage system 120. The employer systems 130, 132, and 134 may include HRIS systems, in some examples.

The CMCP data management and storage system 120 may be communicatively associated with data storage that stores various data and information pertaining to the management of recruitment of a candidate in a digital resume or wallet. The digital resume or wallet may serve as a central repository for an individual's career-related data, including work history, skills, certifications, soft skills, etc. In some examples, the data and information stored in the data storage may be collected from employers via the employer systems 130, 132, and 134 and/or an applicant tracking system that agree to participate in the CMCP data management and storage system 120, and may include data related to all candidates applying for any of their open positions. The CMCP data management and storage system 120 may integrate with existing ATS and HRIS systems through API connections, allowing employers to easily access job seekers' dynamic digital resumes or wallets and skill sets. In return for participating in the CMCP data management and storage system 120, the employers may be able to glean valuable information from the data related to a role they are posting, such as what percent of qualified job seekers in the CMCP data management and storage system 120 are actively seeking, passively seeking, or not on the market. In addition, they may gain insight into how long similar positions take to fill, with and without recruiter assistance. Hiring companies in the co-op may also receive recommendations including a limited list of top candidates based on qualification scores, candidates that list themselves as “Actively Seeking” with the option to invite them to apply. In summary, employers may benefit from more informed hiring decisions, as the digital resume or wallet managed by the CMCP data management and storage system 120 may provide a comprehensive view of a job seeker's capabilities, including inferred skills not typically captured in traditional resumes.

Additionally or alternatively, the data and information stored in the data storage may be collected from job seekers themselves via the candidate devices 110, 112, and 114 (and/or from social media accounts associated with the job seeker) that agree to participate in the CMCP data management and storage system 120, and may include information and assessment results with hiring companies participating in the CMCP 222. In some examples, the job seekers may elect to restrict dissemination of their information to certain employers. In some examples, the job seekers may receive recommendations to apply for open positions that the candidates have a high related qualification score or they can opt-in to recommendations for specific positions that they have an interest in but may not have a competitive qualification score. Job Seekers may also gain visibility into what companies are interested in their skillset and are pursuing them as a candidate.

For employers, implementation of the CMCP data management and storage system 120 may lead to increased size of a candidate pool for a job opening, improve visibility into expected TTF for the job opening, and suggest qualified candidates to employers for the job opening. For job seekers, implementation of the CMCP data management and storage system 120 may provide job opening suggestions for roles that fit the candidates qualifications and provide visibility to employers that are looking to fill open roles.

The CMCP data management and storage system 120 may generate candidate profile data, job profile data, and industrial profile data. The candidate profile data may include, for example, name and contact details of all candidates who are registered to use the CMCP data management and storage system 120. The candidate profile data may also include the digital resume or wallet (e.g., or other information related to qualifications) of the respective candidates. The job profile data may include, for example, details of various job positions, job types, job location etc. the industry profile data may include for example profile of the companies and recruiters who are registered to use the CMCP data management and storage system 120 for hiring a candidate. Further, prediction of time to fill a position by a candidate, based on one or more parameters including location, salary, and skill set may also be determined.

The CMCP data management and storage system 120 may include a machine learning inference that analyzes the aggregated candidate profile data to infer additional skills and proficiencies, and enriching a job seeker's profile beyond information explicitly stated. The CMCP data management and storage system 120 may calculates scores for various candidates according to their profile for respective jobs. The candidate scoring system may also configured to assign ranking to various candidates based on the scores calculated.

The CMCP data management and storage system 120 may also include a machine learning inference to calculate the scores and ranking with respect to a job position. The CMCP data management and storage system 120 may further include a recommendation system that is configured to define one or more parameters and predict the hiring probability results offer candidates. Based on the calculated candidate and job scores, the recommendation system may provide a recommendation to the candidates via the candidate devices 110, 112, and 114 and employers via the employer systems 130, 132, and 134.

In some examples, the CMCP data management and storage system 120 may generate and maintain a certified digital resume or wallet, validate and work history via a verified trusted third party (VTTP), and/or store the validation in the data storage. Thus, when the job seeker applies to a job, the validated work history and achievements may be deemed “Certified” through a predetermined validation process via a VTTP. In some examples, the CMCP data management and storage system 120 may selectively organize the digital resume or wallet for a job seeker when applying for a role to highlight skills that are relevant to the role, such as placing information most relevant to skills desired for the role earlier in the application. This functionality may be enabled and performed by a machine learning inference.

In some examples, the CMCP data management and storage system 120 may receive and retain or hold (e.g., store at the data storage) certifications (e.g., including professional memberships) that are considered “static data” and “non-static data.” In some examples, these certifications may be accepted through predetermined acceptable validation processes including but not limited to API connections, background checks by VTTP, etc.

In some examples, the job seeker may provide to the CMCP data management and storage system 120 background checks ran by previous background check companies, clearing houses, or other VTTPs. This data may be made available by the CMCP data management and storage system 120 in their profile and may be provided to an employer at the discretion of the job seeker (e.g., as governed by any local or national governing laws and regulations).

In some examples, the CMCP data management and storage system 120 may provide the job seeker with a partial or full history of any application(s) that have been submitted inside the ecosystem of the CMCP data management and storage system 120. The job application history may include status updates and various feedback mechanisms, which can be automated and/or entered manually by anyone in the job application or interview process that has appropriate access.

The CMCP data management and storage system 120 may also include a “data co-op” style compensation data analytics tool (CDA). To participate in the CDA, the job seeker must be willing to share certain aspects of their compensation to a larger pool of data with correlating data that will identify the seniority and type of role that is correlated to their compensation, but may allow the identity of the job seeker to remain anonymous.

Various aspects of the CMCP data management and storage system 120 may be shared with other members of the CMCP data management and storage system 120 ecosystem. The level and definitions of which data will be shared may be outlined in a governing policy, such as a “Terms and Conditions” policy but not limited to any document. The level of data available to be shared to other members of the CMCP data management and storage system 120 ecosystem may be controlled and throttled at various degrees at the discretion of the job seeker and the governing documents of the CMCP data management and storage system 120 governing documentation. In some examples, one benefit of the data co-op enabled by the CMCP data management and storage system 120 is that it enhances a value of the job seeker's career along their career journey.

In some examples, to participate in data co-op operated by the CMCP data management and storage system 120, the job seeker may agree to a data contract ownership to maximize the reciprocal value of the job seeker and the CMCP data management and storage system 120 to help manage their career as well as job applications, background checks, and other valuable information in the employment process. The job seeker may retain ownership of their data, and can withdraw it at any time. The data may be designed to be portable from job to job.

In some examples, the CMCP data management and storage system 120 may employ a machine learning inference trained to analyze a job seeker's data (e.g., work history, educational history, certifications/memberships, skills, etc.) and to provide feedback to the job seeker. The CMCP data management and storage system 120 may dynamically map the job seeker's current skills and qualifications against their desired job roles or career goals, providing a visual representation of career progression. For example, the machine learning inference of the CMCP data management and storage system 120 may identify a skill gap for a type of role the job seeker is interested in pursuing. The skill gap may be related to particular experience, a certification, some sort of education, etc. The machine learning inference of the CMCP data management and storage system 120 may identify may recommend relevant educational opportunities to bridge those skill gaps, promoting continuous learning and career development. That is, the CMCP data management and storage system 120 may generate short and long term goals for a candidate that is pursuing promotion to a higher level job (or a job in a different discipline or industry). The short and long term goals may include types of work experience or roles, education, certifications, etc., that people in the higher level job typically have. In addition, the CMCP data management and storage system 120 may identify an amount of experience, etc., that the job seeker in each role to acquire the requisite skills for the higher level job. In some examples, based on a job seeker acquiring a threshold amount of experience in a role, the CMCP data management and storage system 120 may notify a job seeker that they should consider pursuing the next role on their path to the higher level job. This functionality may be enabled and performed by the machine learning inference. The CMCP data management and storage system 120 may update the digital resume or wallet in real-time as job seekers acquire new skills, certificates, or work experience, to ensure that the job seeker's career plan remains aligned with job market trends and industry demands.

As disclosed above, the CMCP data management and storage system 120 may include an artificial intelligence (AI) module with machine learning capabilities to keep learning with each candidate, the data that is gathered throughout the process and thereby to improve accuracy of the prediction by the CMCP data management and storage system 120. The AI module may be configured to gather data from the candidate devices 110, 112, and 114 and/or the employer systems 130, 132, and 134.

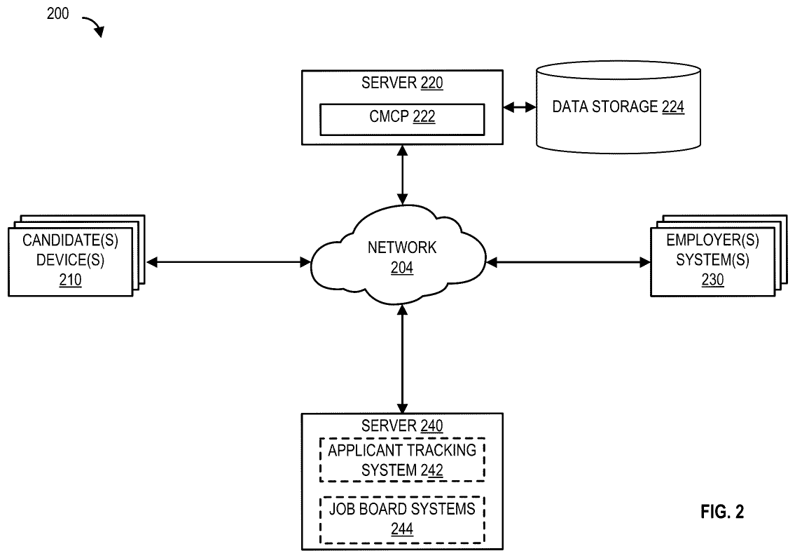

FIG. 2 illustrates a block diagram of a system 200 for managing recruitment processes among job seekers (e.g., candidates) and employers in accordance with embodiments described herein. The CMCP data management and storage 120 of FIG. 1 may implement the CMCP 222 in some examples. The system 200 may include one or more candidate devices 210, a server 220 configured to host a CMCP 222 and coupled to data storage 224, one or more servers 240 configured to optionally host an applicant tracking system (ATS) 242 and/or a job board system 244, and one or more employer systems 230. The one or more candidate devices 210, the server 220, the one or more servers 240, and the one or more employer systems 230 may be in communication over a network 204. The network 104 may include any wireless or wired network, or combination thereof. The one or more candidate devices 210 may be associated with one or more job seekers or candidates. The data storage 224 may store user profile data, job profile data, industry profile data, etc.

The one or more candidate devices 210 may be operated by one or more job seekers to communicate with the one or more employer systems 230 to apply for jobs, retrieve job status, etc. The one or more candidate devices 210 may also communicate with the CMCP 222 to store and retrieve personal information, job posting information, and other information managed by the CMCP 222. The one or more candidate devices 210 may also communicate with the job board system 244 to view job postings and apply for posted jobs.

The one or more employer systems 230 may be operated by one or more employers to communicate with the one or more candidate devices 210 to provide job listing information, receive applications for jobs, retrieve job status, etc. The one or more employer systems 230 may also communicate with the CMCP 222 to store and retrieve candidate information, recommendations of qualified candidates, update job posting status, and other information managed by the CMCP 222. The one or more employer systems 230 may also communicate with the ATS 242 to provide or receive applicant information and/or the job board system 244 to provide job postings and receive candidate applications. provide to store and retrieve candidate information, recommendations of qualified candidates, update job posting status, and other information managed by the CMCP 222.

The ATS 242 may aggregate candidate information from the one or more employer systems 230 and serve as a repository candidate pool for future job postings. The job board system 244 may act as an interface between employers and job seekers to facilitate filling of posted jobs.

The CMCP 222 may be communicatively associated with the data storage 224, that stores various data and information pertaining to the management of recruitment of a candidate. In some examples, the data and information stored in the data storage 224 may be collected from employers via the one or more employer systems 230 and/or the ATS 242 that agree to participate in the CMCP 222, and may include data related to all candidates applying for any of their open positions. In return for participating in the CMCP 222, the employers may be able to glean valuable information from the data related to a role they are posting, such as what percent of qualified job seekers in the CMCP 222 are actively seeking, passively seeking, or not on the market. In addition, they may gain insight into how long similar positions take to fill, with and without recruiter assistance. Hiring companies in the co-op may also receive recommendations including a limited list of top candidates based on qualification scores, candidates that list themselves as “Actively Seeking” with the option to invite them to apply.

Additionally or alternatively, the data and information stored in the data storage 224 may be collected from job seekers via the one or more candidate devices 210 that agree to participate in the CMCP 222, and may include information and assessment results with hiring companies participating in the CMCP 222. In some examples, the job seekers may elect to restrict dissemination of their information to certain employers. In some examples, the job seekers may receive recommendations to apply for open positions that the candidates have a high related qualification score or they can opt-in to recommendations for specific positions that they have an interest in but may not have a competitive qualification score. Job Seekers may also gain visibility into what companies are interested in their skillset and are pursuing them as a candidate.

For employers, implementation of the CMCP 222 may lead to increased size of a candidate pool for a job opening, improve visibility into expected TTF for the job opening, and suggest qualified candidates to employers for the job opening. For job seekers, implementation of the CMCP 222 may provide job opening suggestions for roles that fit the candidates qualifications and provide visibility to employers that are looking to fill open roles.

The CMCP 222 may generate candidate profile data, job profile data, and industrial profile data. The candidate profile data may include, for example, name and contact details of all candidates who are registered to use the CMCP 222. The candidate profile data may also include a digital resume or wallet (e.g., including other information related to qualifications) of the respective candidates. The job profile data may include, for example, details of various job positions, job types, job location etc. the industry profile data may include for example profile of the companies and recruiters who are registered to use the CMCP 222 for hiring a candidate. Further, prediction of time to fill a position by a candidate, based on one or more parameters including location, salary, and skill set may also be determined.

The CMCP 222 may include a machine learning inference that calculates scores for various candidates according to their profile for respective jobs. The candidate scoring system may also configured to assign ranking to various candidates based on the scores calculated.

The CMCP 222 may also include a machine learning inference to calculate the scores and ranking with respect to a job position. The CMCP 222 may further include a recommendation system that is configured to define one or more parameters and predict the hiring probability results offer candidates. Based on the calculated candidate and job scores, the recommendation system may provide a recommendation to the candidates via the one or more candidate devices 210 and employers via the one or more employer systems 230.

In some examples, the CMCP 222 may generate and maintain a certified digital resume or wallet. For example, the CMCP 222 may receive take work history and other achievements (e.g., educational history, etc.) deemed important by the job seeker that is to be used and reused in the application process of current and future searches. Where applicable, the CMCP 222 may receive and store validation of this work history and achievement data from a verified trusted third party (VTTP) in the data storage 224. Thus, when the job seeker applies to a job, the validated work history and achievements may be deemed “Certified” through a predetermined validation process via a VTTP. In some examples, the CMCP 222 may selectively organize the digital resume or wallet for a job seeker when applying for a role to highlight skills that are relevant to the role, such as placing information most relevant to skills desired for the role earlier in the application. This functionality may be enabled and performed by a machine learning inference.

In some examples, the CMCP 222 may receive and retain or hold (e.g., store at the data storage 224) certifications (e.g., including professional memberships) that are considered “static data” and “non-static data.” In some examples, these certifications may be accepted through predetermined acceptable validation processes including but not limited to API connections, background checks by VTTP, etc. For example, a job seeker with an accounting background can enter their CPA certification into the CMCP 222 through a VTTP. A CPA certification may be considered static data, since they will always have the CPA at one point in time. Alternatively, the CPA certification status (e.g., active or inactive), according to the outlined requirements of the CPA governing body may be considered non-static.

In some examples, the job seeker may provide to the CMCP 222 background checks ran by previous background check companies, clearing houses, or other VTTPs. This data may be made available by the CMCP 222 in their profile and may be provided to an employer at the discretion of the job seeker (e.g., as governed by any local or national governing laws and regulations).

In some examples, the CMCP 222 may provide the job seeker with a partial or full history of any application(s) that have been submitted inside the ecosystem of the CMCP 222. The job application history may include status updates and various feedback mechanisms, which can be automated and/or entered manually by anyone in the job application or interview process that has appropriate access.

The CMCP 222 may also include a “data co-op” style compensation data analytics tool (CDA). To participate in the CDA, the job seeker must be willing to share certain aspects of their compensation to a larger pool of data with correlating data that will identify the seniority and type of role that is correlated to their compensation, but may allow the identity of the job seeker to remain anonymous.

Various aspects of the CMCP 222 may be shared with other members of the CMCP 222 ecosystem. The level and definitions of which data will be shared may be outlined in a governing policy, such as a “Terms and Conditions” policy but not limited to any document. The level of data available to be shared to other members of the CMCP 222 ecosystem may be controlled and throttled at various degrees at the discretion of the job seeker and the governing documents of the CMCP 222 governing documentation. In some examples, one benefit of the data co-op enabled by the CMCP 300 is that it enhances a value of the job seeker's career along their career journey.

In some examples, to participate in data co-op operated by the CMCP 222, the job seeker may agree to a data contract ownership to maximize the reciprocal value of the job seeker and the CMCP 222 to help manage their career as well as job applications, background checks, and other valuable information in the employment process. The job seeker may retain ownership of their data, and can withdraw it at any time. The data may be designed to be portable from job to job.

In some examples, the CMCP 222 may analyze a job seeker's data (e.g., work history, educational history, certifications/memberships, skills, etc.) and may provide feedback to the job seeker. For example, the CMCP 222 may identify a skill gap for a type of role the job seeker is pursuing. The skill gap may be related to particular experience, a certification, some sort of education, etc. In other examples, the CMCP 222 may generate short and long term goals for a candidate that is pursuing promotion to a higher level job (or a job in a different discipline or industry). The short and long term goals may include types of work experience or roles, education, certifications, etc., that people in the higher level job typically have. In addition, the CMCP 222 may identify an amount of experience, etc., that the job seeker in each role to acquire the requisite skills for the higher level job. In some examples, based on a job seeker acquiring a threshold amount of experience in a role, the CMCP 222 may notify a job seeker that they should consider pursuing the next role on their path to the higher level job. This functionality may be enabled and performed by a machine learning inference.

As disclosed above, the CMCP 222 may include an artificial intelligence (AI) module with machine learning capabilities to keep learning with each candidate, the data that is gathered throughout the process and thereby to improve accuracy of the prediction by the CMCP 222. The AI module may be configured to gather data from the ATS 242, the job board system 244, the one or more candidate devices 210, and/or the one or more employer systems 230.

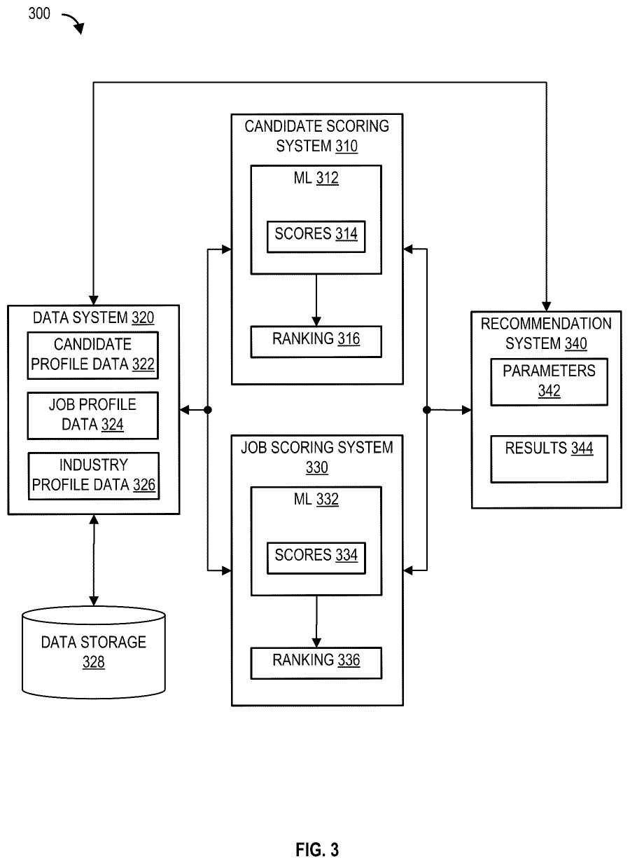

FIG. 3 illustrates a block diagram of a CMCP 300, in accordance with embodiments described herein. The CMCP data management and storage 120 of FIG. 1 and/or storage CMCP 222 of FIG. 2 may implement the CMCP 300 in some examples. The CMCP 300 may include a data system 320, a candidate scoring system 310, a job scoring system 330, and recommendation system 340. The various components of the CMCP 300 may be communicatively associated with the data storage 328, that stores various data and information pertaining to the management of recruitment of a candidate. In some examples, the data and information stored in the data storage 328 may be collected from employers that agree to participate in the CMCP 300, and may include data related to all candidates applying for any of their open positions. In return for participating in the CMCP 300, the employers may be able to glean valuable information from the data related to a role they are posting, such as what percent of qualified job seekers in the CMCP 300 are actively seeking, passively seeking, or not on the market. In addition, they may gain insight into how long similar positions take to fill, with and without recruiter assistance. Hiring companies in the co-op may also receive recommendations including a limited list of top candidates based on qualification scores, candidates that list themselves as “Actively Seeking” with the option to invite them to apply.

Additionally or alternatively, the data and information stored in the data storage 328 may be collected from job seekers that agree to participate in the CMCP 300, and may include information and assessment results with hiring companies participating in the CMCP 300. In some examples, the job seekers may elect to restrict dissemination of their information to certain employers. In some examples, the job seekers may receive recommendations to apply for open positions that the candidates have a high related qualification score or they can opt-in to recommendations for specific positions that they have an interest in but may not have a competitive qualification score. Job Seekers may also gain visibility into what companies are interested in their skillset and are pursuing them as a candidate.

For employers, implementation of the CMCP 300 may lead to increased size of a candidate pool for a job opening, improve visibility into expected TTF for the job opening, and suggest qualified candidates to employers for the job opening. For job seekers, implementation of the CMCP 300 may provide job opening suggestions for roles that fit the candidates qualifications and provide visibility to employers that are looking to fill open roles. The table below provides examples of fields that may be used to determine various metrics associated with a job opening or a candidate.

| Name | Acronym | Description |
|---|---|---|
| Job Seeker | JSSM | This is the measure used to represent a job seeker's potential to |
| Skillset | | fulfill an open role in comparison to other potential applicants |
| Match | | and job requirements after taking “soft” and “hard” skills into |
| | | account. |
| Potential | PCM | This measures “soft skills” variables such as predetermined |
| Cultural | | company values, ethics evaluations, and company culture |
| Match | | valuations to calculate the likelihood of a candidate's |
| | | advancement or hire. |
| Potential | PSM | This measures “hard skills” variables that can be tested and |
| Skills Match | | evaluated such as years of experience, previous roles, role |
| | | specific skills (programming language abilities, Excel abilities, |
| | | design abilities, etc.) |

The data system 320 may generate candidate profile data 322, job profile data 324, and industrial profile data 326. The candidate profile data 322 may include, for example, name and contact details of all candidates who are registered to use the CMCP 300. The candidate profile data 322 also includes a digital resume or wallet (e.g., including other information related to qualifications) of the respective candidates. The job profile data 324 may include, for example, details of various job positions, job types, job location etc. the industry profile data may include for example profile of the companies and recruiters who are registered to use the CMCP 300 for hiring a candidate. Further, prediction of time to fill a position by a candidate, based on one or more parameters 342 including location, salary, and skill set may also be determined.

The candidate scoring system 310 may include a machine learning inference 312 that calculates scores for various candidates according to their profile for respective jobs. The candidate scoring system 310 may also configured to assign ranking 316 to various candidates based on the scores 314 calculated. As explained above, the probability of hiring a candidate is determined based at least the JSSM, the PCM, and the PSM.

The machine learning inference 312 may determine the JSSM for each job seeker based on their soft skills and hard skills independently. The soft skills may be represented by the PCM and the hard skills are represented by the PSM.

The PCM may be based on a candidate's culture score (CS). The machine learning inference may calculate the CS based on an average score (E) assigned to each of the job seeker's soft skills, required in the job posting, over the past n (e.g., integer of 3 or larger) evaluations. For example:

$$C S = {E}_{1} + {E}_{2} + … {E}_{n}$$

Using this information, PCM may be calculated as a current CS divided by a maximum CS for the pool of candidates, such as:

$$P C M = \frac{CS}{max ( f ( x ) : x = C {S}_{1} … {CS}_{n} )} * 100$$

where CS₁ . . . CSₙ are cultural scores calculated for the pool of candidates.

The PSM may be based on a candidate's skills score (SS). The SS may be based on an average job seeker self-identified skill score (JS) related to the role or job, an average of two or more previous recruiter-verified skills scores (RS), and an overall skill score (HS) based on the JS and RS. For example, if last two or more hiring-manager-verified skill scores is higher than the JS, then the HS may equal the average of the last two or more hiring-manager-verified skill scores. If the average of the last two or more hiring-manager-verified skill scores is lower than the JS, then the HS may equal the JS. Using this information, the SS may be calculated as follows:

$$S S = ( RS * 0.7 ) + ( JS * 0.2 ) + ( HS * 0.1 )$$

Using this information. PSM may be calculated as a current SS divided by a maximum SS for the pool of candidates, such as:

$$P S M = \frac{SS}{max ( f ( x ) : x = S {S}_{1} … {SS}_{n} )} * 100$$

where SS₁ . . . SSₙ are calculated skills scores for the pool of candidates. Using the calculated PCM and the PSM, the JSSM may be calculated as follows:

JSSM=(PCM*0.35)+(PSM*0.65)

Similar to the candidate scoring system 310, the job scoring system 330 may include a machine learning inference 332 to calculate the scores 334 and ranking 336 with respect to a job position. The recommendation system 340 is configured to define one or more parameters 342 and predict the hiring probability results 344 offer candidates. Based on the calculated scores 314 by the candidate scoring system 310 and the calculated scores 334 by the job scoring system 330, the recommendation system 340 provides recommendation to the candidates and employers.

In some examples, the CMCP 300 may generate and maintain a certified digital resume or wallet. For example, the CMCP 300 may receive take work history and other achievements (e.g., educational history, etc.) deemed important by the job seeker that is to be used and reused in the application process of current and future searches. Where applicable, the CMCP 300 may receive and store validation of this work history and achievement data from a verified trusted third party (VTTP) in the data storage 328. Thus, when the job seeker applies to a job, the validated work history and achievements may be deemed “Certified” through a predetermined validation process via a VTTP. In some examples, the CMCP 300 may selectively organize the digital resume or wallet for a job seeker when applying for a role to highlight skills that are relevant to the role, such as placing information most relevant to skills desired for the role earlier in the application. This functionality may be enabled and performed by the machine learning inference 312 of the candidate scoring system 310.

In some examples, the CMCP 300 may receive and retain or hold (e.g., store at the data storage 328) certifications (e.g., including professional memberships) that are considered “static data” and “non-static data.” In some examples, these certifications may be accepted through predetermined acceptable validation processes including but not limited to API connections, background checks by VTTP, etc. For example, a job seeker with an accounting background can enter their CPA certification into the CMCP 300 through a VTTP. A CPA certification may be considered static data, since they will always have the CPA at one point in time. Alternatively, the CPA certification status (e.g., active or inactive), according to the outlined requirements of the CPA governing body may be considered non-static.

In some examples, the job seeker may provide to the CMCP 300 background checks ran by previous background check companies, clearing houses, or other VTTPs. This data may be made available by the CMCP 300 in their profile and may be provided to an employer at the discretion of the job seeker (e.g., as governed by any local or national governing laws and regulations).

In some examples, the CMCP 300 may provide the job seeker with a partial or full history of any application(s) that have been submitted inside the ecosystem of the CMCP 300. The job application history may include status updates and various feedback mechanisms, which can be automated and/or entered manually by anyone in the job application or interview process that has appropriate access.

The CMCP 300 may also include a “data co-op” style compensation data analytics tool (CDA). To participate in the CDA, the job seeker must be willing to share certain aspects of their compensation to a larger pool of data with correlating data that will identify the seniority and type of role that is correlated to their compensation, but may allow the identity of the job seeker to remain anonymous.

Various aspects of the CMCP 300 may be shared with other members of the CMCP 300 ecosystem. The level and definitions of which data will be shared may be outlined in a governing policy, such as a “Terms and Conditions” policy but not limited to any document. The level of data available to be shared to other members of the CMCP 300 ecosystem may be controlled and throttled at various degrees at the discretion of the job seeker and the governing documents of the CMCP 300 governing documentation. In some examples, one benefit of the data co-op enabled by the CMCP 300 is that it enhances a value of the job seeker's career along their career journey.

In some examples, to participate in data co-op operated by the CMCP 300, the job seeker may agree to a data contract ownership to maximize the reciprocal value of the job seeker and the CMCP 300 to help manage their career as well as job applications, background checks, and other valuable information in the employment process. The job seeker may retain ownership of their data, and can withdraw it at any time. The data may be designed to be portable from job to job.

In some examples, the CMCP 300 may analyze a job seeker's data (e.g., work history, educational history, certifications/memberships, skills, etc.) and may provide feedback to the job seeker. For example, the CMCP 300 may identify a skill gap for a type of role the job seeker is pursuing. The skill gap may be related to particular experience, a certification, some sort of education, etc. In other examples, the CMCP 300 may generate short and long term goals for a candidate that is pursuing promotion to a higher level job (or a job in a different discipline or industry). The short and long term goals may include types of work experience or roles, education, certifications, etc., that people in the higher level job typically have. In addition, the CMCP 300 may identify an amount of experience, etc., that the job seeker in each role to acquire the requisite skills for the higher level job. In some examples, based on a job seeker acquiring a threshold amount of experience in a role, the CMCP 300 may notify a job seeker that they should consider pursuing the next role on their path to the higher level job. This functionality may be enabled and performed by the machine learning inference 312 of the candidate scoring system 310.

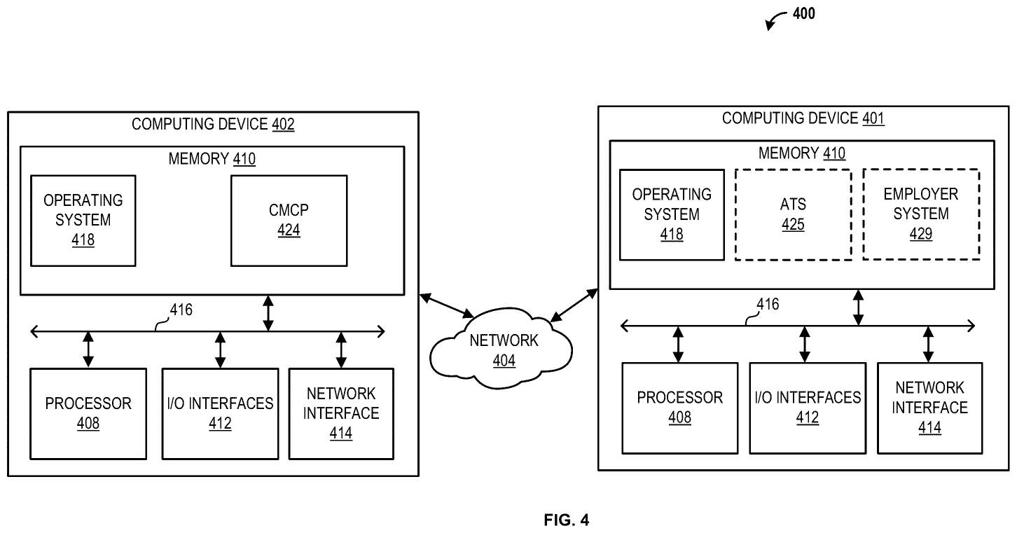

The present methods and systems may be computer-implemented. FIG. 4 is a block diagram depicting a system/environment 400 in accordance with embodiments of the disclosure. The system 400 may include non-limiting examples of a computing device (or server) 401 and a computing device (or server) 402 connected through a network 404. The computing device 401 may implement or host functionality of the employer systems 130, 132, and 134 of FIG. 1 and/or the one or employer systems 230 and/or the ATS 242 of FIG. 2, in some examples. The computing device 402 may implement or host functionality of the CMCP data management and storage system 120 of FIG. 1, and/or the CMCP 222 of FIG. 2, the CMCP 300 of FIG. 3, in some examples. In an aspect, some or all steps of any described method may be performed on a computing device as described herein. The computing device 401 may comprise one or multiple computers configured to store instructions for ATS 425 and/or employer systems 429. The computing device 402 may comprise one or multiple computers configured to store instructions for the CMCP 424 to implement the functionality of the CMCP, described herein. Multiple computing devices 401 and/or 402 may communicate through the network 404.

The computing device 401 and the computing device 402 may be a digital computer that, in terms of hardware architecture, generally includes a processor 408, system memory 410, input/output (I/O) interfaces 412, and network interfaces 414. These components (408, 410, 412, and 414) are communicatively coupled via a local interface 416. The local interface 416 may be, for example, but not limited to, one or more buses or other wired or wireless connections, as is known in the art. The local interface 416 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 408 may be a hardware device for executing software, particularly that stored in system memory 410. The processor 408 may be any custom made or commercially available processor, a central processing unit (CPU), an auxiliary processor among several processors associated with the computing device 401 and the computing device 402, a semiconductor-based microprocessor (in the form of a microchip or chip set), or generally any device for executing software instructions. During operation of the computing device 401 and/or the computing device 402, the processor 408 may execute software stored within the system memory 410, to communicate data to and from the system memory 410, and to generally control operations of the computing device 401 and the computing device 402 pursuant to the software.

The I/O interfaces 412 may be used to receive user input from, and/or for sending system output to, one or more devices or components. User input may be received via, for example, a keyboard and/or a mouse. System output may be output via a display device and a printer (not shown). I/O interfaces 412 may include, for example, a serial port, a parallel port, a Small Computer System Interface (SCSI), an infrared (IR) interface, a radio frequency (RF) interface, and/or a universal serial bus (USB) interface.

The network interface 414 may be used to transmit and receive from the computing device 401 and/or the computing device 402 on the network 404. The network interface 414 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The system memory 410 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 410 may incorporate electronic, magnetic, optical, and/or other types of storage media. Note that the system memory 410 may have a distributed architecture, where various components are situated remote from one another, but may be accessed by the processor 408.

The software in system memory 410 may include one or more software programs, each of which comprises an ordered listing of executable instructions for implementing logical functions. In the example of FIG. 4, the software in the system memory 410 of the computing device 401 may comprise instructions for the CMCP 424, and a suitable operating system (0/S) 418. In the example of FIG. 4, the software in the system memory 410 of the computing device 402 may comprise instructions for the employer system 429 or the ATS 425, and a suitable operating system (O/S) 418. The operating system 418 essentially controls the execution of other computer programs and may enable virtualization of the CMCP 424, the ATS 425, and/or the employer system 429. In some examples, the O/S is a hypervisor configured to host virtual machines or containers to support virtualization.

For purposes of illustration, application programs and other executable program components such as the operating system 418 are shown herein as discrete blocks, although it is recognized that such programs and components may reside at various times in different storage components of the computing device 401 and/or the computing device 402. An implementation of the system/environment 400 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

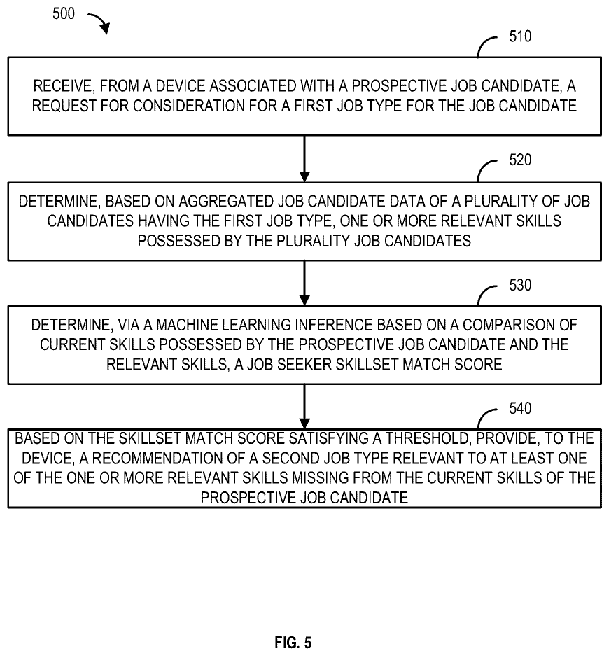

FIG. 5 depicts a flowchart of an example method 500 to evaluate job seeker qualifications via a CMCP in accordance with embodiments of the disclosure. The method 500 may be performed in whole or in part by a single computing device, a plurality of computing devices, and the like. For example, the method 500 may be performed by the CMCP data management and storage system 120 of FIG. 1, the CMCP 222 of FIG. 2, the CMCP 300 of FIG. 3, the CMCP 424 hosted on the computing device 401 of FIG. 4, or any combination thereof.

The method 500 may include receiving, from a device associated with a prospective job candidate, a request for consideration for a first job type for the job candidate, at 510. In some examples, the device includes one of candidate devices 110, 112, and 114 of FIG. 1 and/or one of the one or more of the candidate devices 210 of FIG. 2.

The method 500 may include determining, based on aggregated job candidate data of a plurality of job candidates having the first job type, one or more relevant skills possessed by the plurality job candidates, at 520. The aggregated job candidate data may be retrieved from the employer systems 130, 132, and 134 of FIG. 1 and/or the ATS 242, the job board system 244, the one or more employer systems 230 of FIG. 2, and/or the ATS 425 and/or the employer system 429 of FIG. 4.

The method 500 may include determining, via a machine learning inference based on a comparison of current skills possessed by the prospective job candidate and the relevant skills, a job seeker skillset match score, at 530. In some examples, the method 500 may further include determining the job seeker skillset match score based on a potential cultural match (PCM) score. In some examples, the PCM score includes at least one soft skill score. In some examples, the at least one soft skill score includes an ethics score, leadership score, a teamwork score, a communication score, or any combination thereof. In some examples, the method 500 may further include determining the job seeker skillset match score based on a potential skills match (PSM) score. In some examples, the method 500 may further include determining the PSM score based on a comparison of a skill score provided by the prospective job candidate and one or more skill scores provided by recruiters or hiring managers.

The method 500 may include based on the skillset match score satisfying a threshold, providing, to the device, a recommendation of a second job type relevant to at least one of the one or more relevant skills missing from the current skills of the prospective job candidate, at 540. In some examples, the method 500 may further include based on the skillset match score satisfying the threshold, determining, via the machine learning inference, the second job type relevant to the at least one of the one or more relevant skills missing from the current skills of the prospective job candidate. In some examples, the method 500 may further include ranking the one or more relevant skills based on a quantity of the plurality of job candidates having a respective skill, an amount of experience developing a respective skill, or a combination thereof. In some examples, the method 500 may further include further comprising determining, via the machine learning inference, the second job type based on a highest ranked skill of the one or more relevant skills missing from the current skills of the prospective job candidate.

### EXAMPLE

Below is an example calculation of JSSM as described with reference to FIG.

Job Seeker, Bill, has the following averages assigned to his soft skills over his past three evaluations.
Leadership: 78/100
Teamwork: 86/100
Communication: 62/100

As a result, CS=0.78+0.86+0.62=2.26

Bill's skills may then be compared to the highest CS found in the pool of active potential applicants, which is 0.88 in this example. This comparison may result in the Potential Cultural Match (PCM), as shown below:

$$PCM = ( 2.26 / 2.706 ) * 100 = 83.518$$

Bill's “hard skills” may also be evaluated against other active potential applicants by calculating a Skill Score (SS) for each of his relevant “hard skills”. For example, Bill may rate his skill (JS) related to JavaScript and PHP were 76/100 and 84/100, respectively, and the average of his last two recruiter verified skill scores (RS) were 82/100 for JavaScript and 71/100 for PHP. Past hiring managers for roles that Bill has interviewed for may have rated his JavaScript skills at 74/100 and PHP skills at 87/100.

Based on this information, the following calculations may be performed:

$$\begin{matrix}JS = Avg ( 0.76 \& 0.84 ) = 0.8 \\ RS = Avg ( 0.82 \& 0.71 ) = 0.765 \\ HS = Avg ( 0.76 \& 0.87 ) = 0.815\end{matrix}$$

Note that 0.76 comes from the job seeker's self proclaimed skill score because the hiring manager's score was lower, and the 0.87 comes from the hiring manager because it was higher than the job seeker's personal assessment.

$$SS = ( 0.765 * 0.7 ) + ( 0.8 * 0.2 ) + ( 0.815 * 0.1 ) = 0.777$$

Bill may then be compared to the highest Skill Score (SS) found in the pool of active potential applicants, which in is 0.85 in this example. This comparison may result in the Potential Cultural Match (PCM), as shown below:

PSM=(0.777/0.85)*100=91.412

As a result, Bill's JSSM score may be calculated as follows:

JSSM=(83.518*0.35)+(91.412*0.65)=88.649

Thus, the final JSSM result for Bob in this role is 88.649. One of skill in the art will appreciate that this example is a non-limiting that shows how the JSSM score could be calculated for a particular person.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, from a device associated with a prospective job candidate, a request for consideration for a first job type for the job candidate;
determining, based on aggregated job candidate data of a plurality of job candidates having the first job type, one or more relevant skills possessed by the plurality job candidates;
determining, via a machine learning inference based on a comparison of current skills possessed by the prospective job candidate and the relevant skills, a job seeker skillset match score; and
based on the skillset match score satisfying a threshold, providing, to the device, a recommendation of a second job type relevant to at least one of the one or more relevant skills missing from the current skills of the prospective job candidate.

2. The method of claim 1, further comprising, based on the skillset match score satisfying a threshold, determining, via the machine learning inference, the second job type relevant to the at least one of the one or more relevant skills missing from the current skills of the prospective job candidate.

3. The method of claim 2, further comprising determining, via the machine learning inference, the second job type based on a highest ranked skill of the one or more relevant skills missing from the current skills of the prospective job candidate.

4. The method of claim 3, further comprising ranking the one or more relevant skills based on a quantity of the plurality of job candidates having a respective skill, an amount of experience developing a respective skill, or a combination thereof.

5. The method of claim 1, further comprising determining the job seeker skillset match score based on a potential cultural match (PCM) score.

6. The method of claim 5, wherein the PCM score includes at least one soft skill score.

7. The method of claim 6, wherein the at least one soft skill score includes an ethics score, leadership score, a teamwork score, a communication score, or any combination thereof.

8. The method of claim 1, further comprising determining the job seeker skillset match score based on a potential skills match (PSM) score.

9. The method of claim 8, further comprising determining the PSM score based on a comparison of a skill score provided by the prospective job candidate and one or more skill scores provided by recruiters or hiring managers.

10. The method of claim 1, further comprising receiving aggregated job candidate data of a plurality of job candidates from an application tracking system.

11. A system comprising:
a device associated with a prospective job candidate configured to provide a request for consideration for a first job type for the job candidate; and
a career management co-op platform (CMCP) system configured to:
receive the request;
determine, based on aggregated job candidate data of a plurality of job candidates having the first job type, one or more relevant skills possessed by the plurality job candidates;
determine, via a machine learning inference based on a comparison of current skills possessed by the prospective job candidate and the relevant skills, a job seeker skillset match score; and
based on the skillset match score satisfying a threshold, provide, to the device, a recommendation of a second job type relevant to at least one of the one or more relevant skills missing from the current skills of the prospective job candidate.

12. The system of claim 11, wherein the CMCP system is further configured to, based on the skillset match score satisfying a threshold, determine, via the machine learning inference, the second job type relevant to the at least one of the one or more relevant skills missing from the current skills of the prospective job candidate.

13. The system of claim 12, wherein the CMCP system is further configured to determine, via the machine learning inference, the second job type based on a highest ranked skill of the one or more relevant skills missing from the current skills of the prospective job candidate.

14. The system of claim 13, wherein the CMCP system is further configured to rank the list of relevant skills based on a quantity of the plurality of job candidates having a respective skill, an amount of experience developing a respective skill, or a combination thereof.

15. The system of claim 11, wherein the CMCP system is configured to determine the job seeker skillset match score based on a potential cultural match (PCM) score.

16. The system of claim 15, wherein the PCM score includes at least one soft skill score.

17. The system of claim 16, wherein the at least one soft skill score includes an ethics score, leadership score, a teamwork score, a communication score, or any combination thereof.

18. The system of claim 11, wherein the CMCP system is configured to determine the job seeker skillset match score based on a potential skills match (PSM) score.

19. The system of claim 18, wherein the CMCP system is configured to determine the PSM score based on a comparison of a skill score provided by the prospective job candidate and one or more skill scores provided by recruiters or hiring managers.

20. The system of claim 11, wherein the CMCP system is configured to receive aggregated job candidate data of a plurality of job candidates from an application tracking system.
